(19) United States
(12) Patent Application Publication
(10) Pub. No.: US 2022/0279927 A1
(43) Pub. Date: Sep. 8, 2022

(54) A VACUUM CHAMBER SYSTEM

(71) Applicant: Oren NAIM, Tel Aviv (IL)

(72) Inventor: Oren NAIM, Tel Aviv (IL)

(21) Appl. No.: 17/625,754

(22) PCT Filed: Jul. 12, 2020
(86) PCT No.: PCT/IL2020/050778

§ 371 Date: Jan. 9, 2022

(30) Foreign Application Priority Data
Jul. 15, 2019 (IL) 268079

(51) Int. Cl. A47B 88/963; B65B 31/02

(52) U.S. Cl. CPC A47B 88/963; B65B 31/025

(57) ABSTRACT

A vacuum chamber system comprising a housing defining therein a chamber cavity, and an opening in the housing leading to the chamber cavity; The housing has a sealing rim extending around the opening; The vacuum chamber system also comprises a container configured for being accommodated within the housing and comprising a panel formed with a sealing area corresponding in size and shape to the sealing rim; The container is configured for transposing at least between a first, closed position in which the container is received within the housing and the sealing area thereof is juxtaposed against the sealing rim, and a second, open position in which the container at least partially protrudes from the housing and the sealing area is spaced from the sealing rim; The vacuum chamber system also comprises a pressure mechanism configured for withdrawing air from the chamber cavity at least when the container is in its first, closed position, thereby creating an under pressure within the chamber cavity and a sealing between the sealing rim and the sealing area, thereby defining a third, sealed position of the container.

### TECHNOLOGICAL FIELD

The present invention is in the field of vacuum chambers, in particular, vacuum chambers incorporated into cabinets, closets and drawers.

### BACKGROUND OF THE INVENTION

It is well known in the art to use vacuum sealing in order to preserve food and other items to which exposure to ambient air may cause decay, decomposition or other harmful effects, and for minimizing storage space. In particular, using vacuum may allow prolonging the lifespan of such foods and items.

One way of utilizing vacuum involves specialized vacuum packages into which food or other items are inserted, whereafter the air is withdrawn from such packages to form a vacuum. Examples of such packages are zip-lock vacuum bags, vacuum sealed containers etc.

Another way of utilizing vacuum involves the use of specially formed vacuum chambers. Such chambers usually include a cavity sealed by a door or cover, and a mechanism configured for withdrawing the air from the container after being sealed.

Acknowledgement of the above references herein is not to be inferred as meaning that these are in any way relevant to the patentability of the presently disclosed subject matter.

### GENERAL DESCRIPTION

In accordance with one aspect of the subject matter of the present application, there is provided a vacuum chamber system comprising:
a housing defining therein a chamber cavity, and an opening in said housing leading to said chamber cavity, said housing having a sealing rim extending around the opening;
a container configured for being accommodated within the housing and comprising a panel formed with a sealing area corresponding in size and shape to said sealing rim; said container being configured for transposing at least between a first, closed position in which the container is received within the housing and the sealing area thereof is juxtaposed against the sealing rim, and a second, open position in which the container at least partially protrudes from the housing and said sealing area is spaced from said sealing rim; wherein said container further comprises a support structure configured for being received within the housing in said first, closed position; and
a pressure mechanism configured for withdrawing air from the chamber cavity at least when said container is in its first, closed position, thereby creating an under pressure within the chamber cavity and a sealing between the sealing rim and the sealing area, thereby defining a third, sealed position of the container, wherein said support structure is configured for providing structural support to the housing in said sealed position.

It should be noted that the panel may also include a peripheral portion extending beyond the sealing area. Thus, the sealing area of the panel does not have to be defined by an outer circumference of the panel and is designed in accordance with the dimensions of the sealing rim.

The support structure may be configured for at least partially abutting an inner portion of the housing walls proximal to the opening, thereby providing the required structural support. It should be noted that the support structure may even extend along the container and also provide support to the housing in portions of the housing remote from the opening.

The housing may be configured for being properly sealed on all areas of the housing other than the opening, for preventing ingress of air into the chamber cavity at least in the third, sealed position of the chamber.

The container may be formed with a container cavity configured for receiving items therein, wherein the container cavity and the chamber cavity are in fluid communication with one another. Thus, at least in the first, closed position, the container cavity and chamber cavity may form together a mutual space, wherein, upon generating under pressure within the chamber cavity, the container cavity is similarly under pressured.

The container may comprise an opening allowing the user access to the container cavity, at least in the second, open position. In accordance with one example, the opening may comprise a cover or lid configured for closing the opening. However, it should be understood that the lid/cover is not configured for sealing off the container cavity (separating it from the chamber cavity), and still allows fluid communication between the container cavity and the chamber cavity. Thus, the vacuum in the container cavity is caused by under pressure of the chamber cavity, and not by independently pressurizing the container cavity. For example, the cover may have holes or apertures therein, allowing said fluid communication, and is simply used as a functional barrier rather than as a seal.

The container may transpose continuously between the first, closed position and the second, open position to assume a plurality of intermediate positions therebetween. When the chamber is under pressured, and sealing is provided between the sealing rim and the sealing area, the container may be considered to be in a third, sealed position.

In accordance with one example, the container may transpose between the first, closed position and the second, open position (and vise versa) by linear displacement, e.g. a drawer. Alternatively, the container may transpose between the above mentioned positions by a revolving motion.

The panel of the container may be oriented along a plane generally transverse to the direction of movement of the container in its transition between the first, closed position and the second, open position. The container may further comprise a bottom configured for supporting any items placed in the container. The container may be configured for transposing between the positions in a generally horizontal manner (e.g. a drawer), or in a vertical manner similar to a compartment configured for being pulled upwards for its opening. In the horizontal case, the bottom may be oriented along a plane transverse to the panel, while in the vertical case, the bottom may be oriented along a plane generally parallel to that of the panel.

The vacuum chamber system may comprise a sealing member interposed between the sealing rim and the sealing area, configured for providing the required sealing of the opening to ensure the vacuum is maintained. The sealing member may be integrally formed with the opening, integrally formed with the panel or a stand alone member configured for being fitted to either of the opening or the panel for providing the required sealing.

The sealing member may have resilient properties, so that when the sealing area is juxtaposed with the sealing rim, the sealing member is trapped between the latter and the former, and is configured for sealingly filling the gap between the two, at least when the pressure mechanism begins withdrawing air from the chamber cavity.

The housing may comprise a rear panel configured for closing off the chamber cavity on the rear end thereof. In accordance with a particular example, instead of being fitted to the rear end of the walls of the housing, the rear panel may be received and held within a grooves formed in the housing walls. In particular, the rear panel may have dimensions greater than the cross-section of the chamber cavity such that a peripheral rim of the rear panel is received within the grooves of the housing walls. The grooves may be in the form of slits, formed on and inner side of the housing walls, and, in accordance with a particular example, do not extend across to the exterior of the housing walls.

In construction, some of the housing walls may be assembled leaving sufficient space to place the rear panel within the grooves (e.g. in a sliding manner), and thereafter the remaining housing walls may be assembled, enclosing the rear panel. In addition, sealing material may be introduced into the grooves, facilitating proper sealing during at least the third, sealing position.

The above arrangement provides, inter alia, several advantages concerned with the sealing of the chamber, some of which being:
improved structural integrity—the rear panel provides structural support against buckling of the housing walls while, at the same time, being prevented from being dislodged;
improved sealing—the groove allows more convenient sealing of the edges of the rear panel compared to it being fitted to the rear end of the housing walls since sealing material may be introduced into the grooves, thereby forming a sealing enclosing the periphery of the panel on all sides (both from the front and from the rear); and
single structure—allows dividing the housing into two spaces, one constituting the vacuum chamber and the other constituting a service or functional compartment, while the walls of the housing are mutual for both spaces. In other words, instead of an assembly of two compartments together, this configuration allows maintaining the housing as a single until while dividing it into two spaces.

The chamber may comprise a functional compartment, separate from the chamber cavity, configured for housing therein at least the pressure mechanism. The pressure mechanism may include at least one of the following:
a pump;
a control module;
a pressure regulation arrangement;
one or more pressure sensors; and
one or more pressure display components

The pump may be in fluid communication with the chamber cavity for allowing it to withdraw air therefrom, at least in the first, closed position. The pump may be associated with the control module, wherein the control arrangement may be configured for activating/stopping operation of the pump. Controlling operation of the pump by the control module may be associated either with direct commands input by the user or by predetermined conditions.

In particular, when not initiated by the user, the control module may be configured for stopping operation of the pump either upon reaching a predetermined desired under-pressure within the chamber cavity and/or after a predetermined amount of time, and also to activate the pump upon indication that the container has transposed into its first, closed position.

In accordance with a particular example, the chamber cavity may comprise a trigger component (e.g. a sensor, a button etc.) configured for being activated by the container, when the latter is transposed into its first, closed position.

When initiated by the user, the pump may be activated/stopped by physical command (pressing a button or turning on a switch), or remotely via wi-fi, cellular, control app on the smartphone etc.

The pressure mechanism may further comprise a pressure balancing valve configured for allowing controlled ingress of air from outside the chamber into the chamber cavity in order to balance the pressure between the latter and the former, thereby allowing transposing the container from the first, closed position to the second, open position. Specifically, when the chamber is in its third, sealed position, the under pressure within the chamber cavity will not allow withdrawing the container from the housing.

When a user desires to withdraw the container, they must first operate the pressure balancing valve in order to balance the pressure. Such operating may be performed physically, e.g. by manipulating a pressure activator, which may be part of the valve, or be associated with the valve. Alternatively, such operation may be performed remotely via wi-fi, cellular, control app on the smartphone etc.

In accordance with one example of the above, the pressure activator may be incorporated into the panel, and may even be, for example, integrated with a handle formed on the panel, and configured for transposing the container between positions (e.g. a drawer handle). Alternatively, the pressure activator may be incorporated in the housing (externally), and may be in the form of a push-button, pull-button, lever, faucet etc.

The pressure control module may also comprise at least one pressure relief valve configured for regulating the pressure within the chamber cavity. Specifically, the pressure relief valve may be configured for regulating the under-pressure in order to ensure that it is within the pre-defined boundaries associated with the structural requirement of the chamber, i.e. preventing the under-pressure within the chamber cavity from reaching levels which may hinder the structure of the housing.

In construction, the housing may comprise three or more walls transverse to one another, each of said walls having an inner face facing the chamber cavity and at least one contact angled to said inner face. For example, the contact surfaces may be in the form of a chamfer, such that when the respective contact surfaces of two adjacent walls are mated, the mating interface forms an interface line extending at an angle to the inner surfaces of both walls.

In accordance with a particular example, the angle of the contact surface may be determined according to the angle between the two adjacent walls. Specifically, it may be desired that the angle of the contact surface is such that the interface line is the bisector of the angle between the two adjacent walls. Thus, for a housing having a generally rectangular cross section, the chamfer angle may be 45° while for a housing having a generally triangular cross section, the chamfer angle may be 60°.

The above configuration of an angled interface allows providing an additional level of structural stability when the chamber cavity is under pressure, preventing the collapse of any of the two adjacent walls under said pressure. In addition, owing to this design, the interface may have a small surface area compared to male/female interfaces or more elaborate interfaces, said small surface area reducing the probability of leaks when implemented in the vacuum configuration of the present application.

The housing may be made of a material sufficiently rigid so as to withstand the structural pressure of the chamber cavity being under vacuum, while, simultaneously, having some degree of mechanical plasticity. One example of such a material may be wood such as pine, Yew, Oak, Birch etc. However, it should be appreciated that the housing may be made of additional materials such as plastic, metal etc.

In addition, the walls of the housing may have a coating configured for providing the housing with additional structural properties. Such coating may be configured for binding all the walls of the housing together. One example of such a coating may be resin.

It should be noted that the above mentioned structural features of the housing, container and sealing arrangement, individually or collaboratively, facilitate not only the structural integrity of the housing, at least in said third, sealed position, but also allow achieving said structural integrity while maintaining relatively thin walls compared to the cross section of the housing. In particular, the ratio between the cross-sectional length and an average thickness of the housing wall may range between 20 to 40, more particularly between 24 and 35, and even more particularly between 27 and 30. The term cross-sectional length should be understood here as the maximum length taken along a cross-sectional plane perpendicular to the longitudinal direction of the housing. For a housing with a rectangular cross-section, the maximum length may be taken as the diagonal of the cross-section. The ratio of chamber cavity volume to wall volume may be similarly high, ranging between 2.5 to 10.

The above described structural features may provide, inter alia, the advantage of using a relatively small amount of structural material for obtaining a relatively large container volume. In accordance with a particular example, a vacuum chamber system of the present invention may comprise a housing with chamber cavity dimensions of 400 mm×250 mm×600 mm (width×height×depth respectively), the housing having a wall thickness of around 17 mm. This provides a cross-sectional diagonal of about 47 cm, yielding a ratio of roughly 27.5. Similarly, this provides a chamber cavity volume of roughly 60,000 cm³ (0.06 m³), while having a volume of about 14,000 cm³, yielding a ratio of about 4.28.

Notwithstanding the above, and with no inherent limitations, the vacuum chamber system of the present application may be incorporated, but is not limited to, in household furniture such as a vacuum drawer, especially with regards to food. Specifically, the chamber may be used as a vacuum drawer where any type of food may be placed, cooled or uncooled, wherein generating under-pressure within the chamber may facilitate a longer lifespan and increased freshness for a longer duration of the foods placed in the chamber.

The implementation of the vacuum chamber as described above forms a system in which, in the third, sealed position, when under-pressure is applied, the chamber functions as a vacuum chamber, wherein, when the pressure is released, the chamber functions as a completely regular drawer. This is opposed to known vacuum drawers which simply comprise a vacuum chamber therein, requiring access to the vacuum chamber after the drawer has been withdrawn.

In addition, one of the advantages of the present invention is in providing a system under which standard drawers may be converted to vacuum drawers by a fairly minimal modification, including only the replacement of the front panel of the drawer and providing the pressure mechanism. In addition, the front panel may be designed according to the current design of a given item of furniture (e.g. kitchen cabinet), whereby the outside appearance of the furniture is not affected by the aforementioned modification.

The vacuum chamber may constitute part of a vacuum chamber system comprising a plurality of such vacuum chambers. Each of the vacuum chambers may be provided with its own pressure pump or, alternatively, some or all of the chambers may be sharing a mutual pressure pump. Similarly, the control modules may be mutual to some or all of the chambers.

In accordance with another aspect of the subject matter of the present application, there is provided a vacuum chamber system comprising:
a housing comprising one or more housing walls defining therein a chamber cavity, and an opening in said housing leading to said chamber cavity, said housing having a sealing rim extending around the opening, and a rear panel remote from the opening, said rear panel being received within grooves formed in said housing walls;
a container configured for being accommodated within the housing and comprising a panel formed with a sealing area corresponding in size and shape to said sealing rim; said container being configured for transposing at least between a first, closed position in which the container is received within the housing and the sealing area thereof is juxtaposed against the sealing rim, and a second, open position in which the container at least partially protrudes from the housing and said sealing area is spaced from said sealing rim; and
a pressure mechanism configured for withdrawing air from the chamber cavity at least when said container is in its first, closed position, thereby creating an under pressure within the chamber cavity and a sealing between the sealing rim and the sealing area, thereby defining a third, sealed position of the container.

In accordance with yet another aspect of the subject matter of the present application, there is provided a vacuum chamber system comprising:
a housing having one or more housing walls defining therein a chamber cavity, and an opening in said housing leading to said chamber cavity, said housing having a sealing rim extending around the opening, wherein said one or more housing walls have a nominal thickness t and said chamber cavity having a maximal cross-section L such that the ratio of L/t is greater than 15;
a container configured for being accommodated within the housing and comprising a panel formed with a sealing area corresponding in size and shape to said sealing rim; said container being configured for transposing at least between a first, closed position in which the container is received within the housing and the sealing area thereof is juxtaposed against the sealing rim, and a second, open position in which the container at least partially protrudes from the housing and said sealing area is spaced from said sealing rim; and
a pressure mechanism configured for withdrawing air from the chamber cavity at least when said container is in its first, closed position, thereby creating an under pressure within the chamber cavity and a sealing between the sealing rim and the sealing area, thereby defining a third, sealed position of the container.

### BRIEF DESCRIPTION OF THE DRAWINGS

In order to better understand the subject matter that is disclosed herein and to exemplify how it may be carried out in practice, embodiments will now be described, by way of non-limiting example only, with reference to the accompanying drawings, in which:

FIG. 1A is a schematic isometric view of a vacuum chamber system in accordance with the present application;

FIG. 1B is a schematic isometric view of a housing of the vacuum chamber system shown in FIG. 1A;

FIG. 1C is a schematic isometric view of a housing wall used in the vacuum chamber system shown in FIGS. 1A and 1B;

FIG. 1D is a schematic isometric view of a rear panel during assembly into the housing walls shown in FIG. 1C;

FIG. 2A is a schematic isometric view of the vacuum chamber system shown in FIG. 1, shown in a second, open position;

FIG. 2B is a schematic perpendicular cross section of the vacuum chamber system shown in FIG. 2A;

FIG. 3A is a schematic isometric view of the vacuum chamber system shown in FIG. 1, shown in a first, closed position;

FIG. 3B is a schematic perpendicular cross section of the vacuum chamber system shown in FIG. 3A;

FIG. 4A is a schematic isometric view of the vacuum chamber system shown in FIG. 1, shown in a third, sealed position;

FIG. 4B is a schematic perpendicular cross section of the vacuum chamber system shown in FIG. 2A;

FIG. 5 is a schematic cross-section view of a pressure-release valve of the vacuum chamber system of the present application;

FIG. 6 is a schematic cross-section view of a valve mechanism of the vacuum chamber system of the present application;

FIG. 7 is a schematic cross-section view of another example of a housing of the vacuum chamber system of the present application; and

FIGS. 8A to 8C are schematic cross-section views of different geometries of vacuum chamber systems according to the present application.

It will be appreciated that for simplicity and clarity of illustration, elements shown in the figures have not necessarily been drawn accurately or to scale. For example, the dimensions of some of the elements may be exaggerated relative to other elements for clarity, or several physical components may be included in one functional block or element. Further, where considered appropriate, reference numerals may be repeated among the figures to indicate corresponding or analogous elements.

### DETAILED DESCRIPTION OF EMBODIMENTS

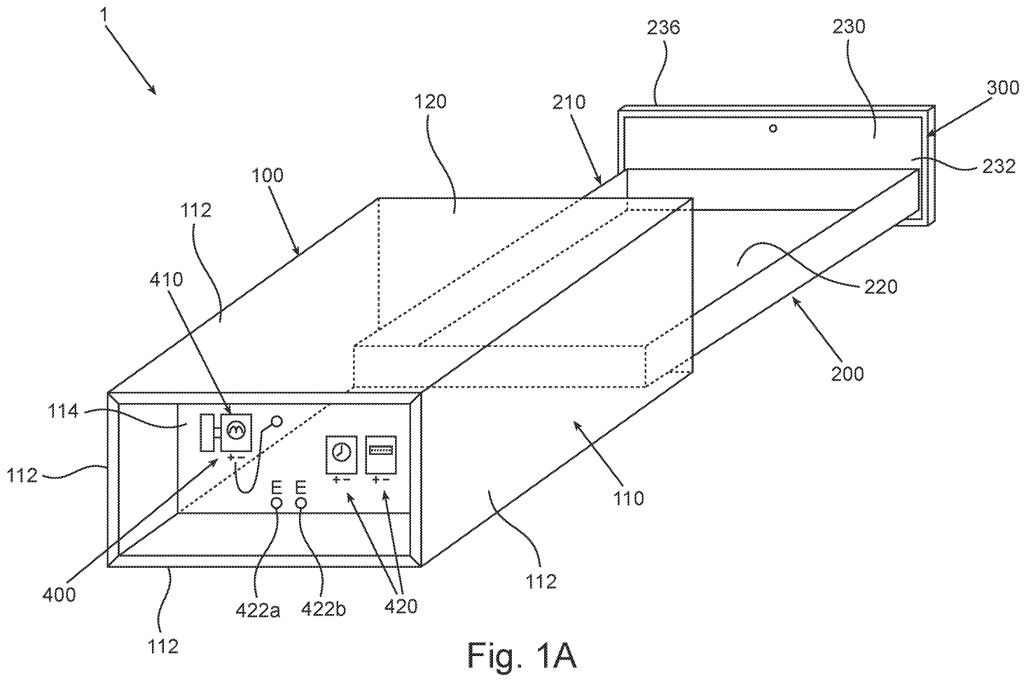

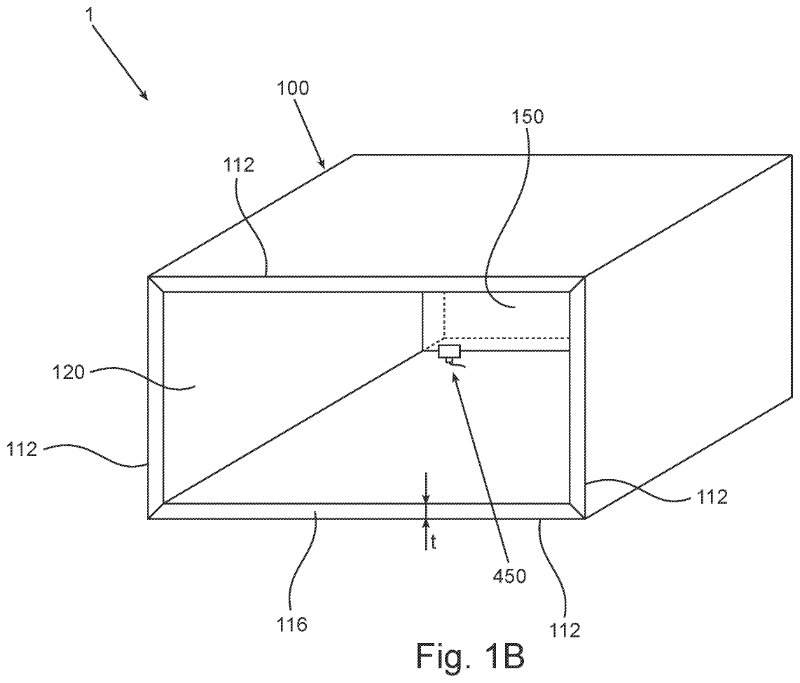

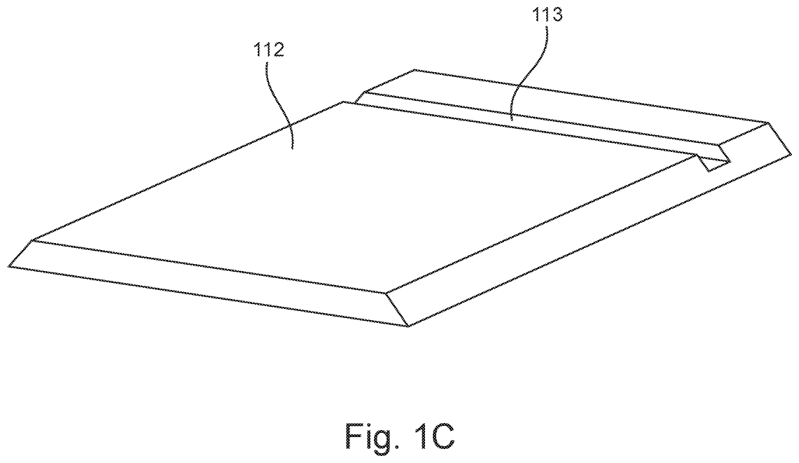

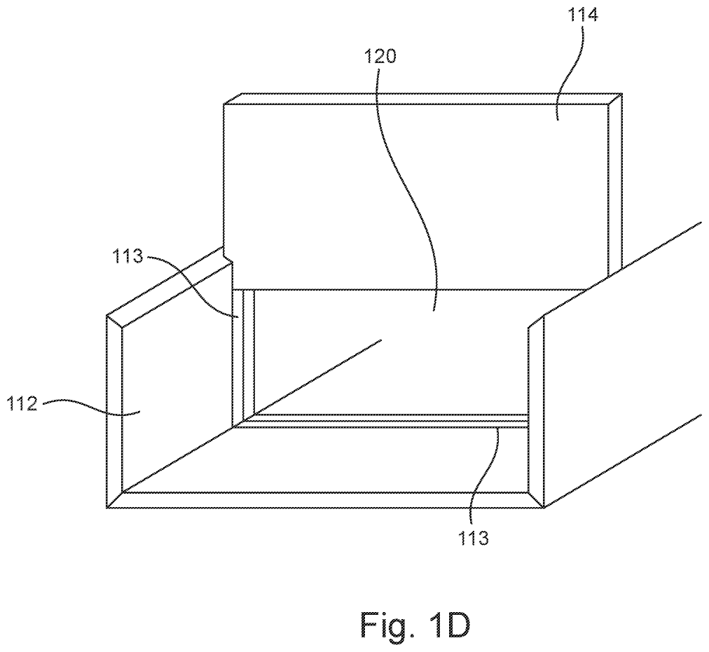

Attention is first drawn to FIGS. 1A and 1B in which a vacuum chamber system (VCS) is shown, generally designated 1, and comprising a housing 100, a container 200, a sealing member 300 and a vacuum mechanism 400. The housing 100 comprises a chamber 110 having a main compartment defining a chamber cavity 120 configured for receiving therein the container 200, at least in a closed position of the VCS 1. The housing 100 further comprises a rear compartment 130 configured for housing the vacuum mechanism 400. The container 200 comprises a container box 210 defining a container cavity 220, and a front panel 230.

The chamber 110 comprises four walls 112 forming a generally rectangular prism, and a rear panel 114, defining together the chamber cavity 120 of the chamber 110. The walls 112 have a thickness t defining a sealing rim 116 at the front of the chamber 110.

With additional reference being made to FIGS. 1C and 1D, the rear panel 114 is positioned within grooves 113 formed on the inner faces of the housing walls 112. In assembly, three of the walls 112 are first assembled such that the grooves 113 form a frame configured for receiving the rear panel 114. The grooves 113 may be filled with adhesive, sealing material etc. whereafter the rear panel 114 is slid into the grooves 113 as shown in FIG. 1D. Once the rear panel 114 is set in place, the last wall 112 can be assembled, a protruding portion of the rear panel 114 being received within a respective groove 113 of the last wall 112.

The front panel 230 has an inner face 232 and comprising a groove 234 in which the sealing member 300 is to be received, thereby defining a sealing area 236 of the front panel 230. The sealing member 300 is made of a resilient material configured for undergoing compression or deformation under pressure.

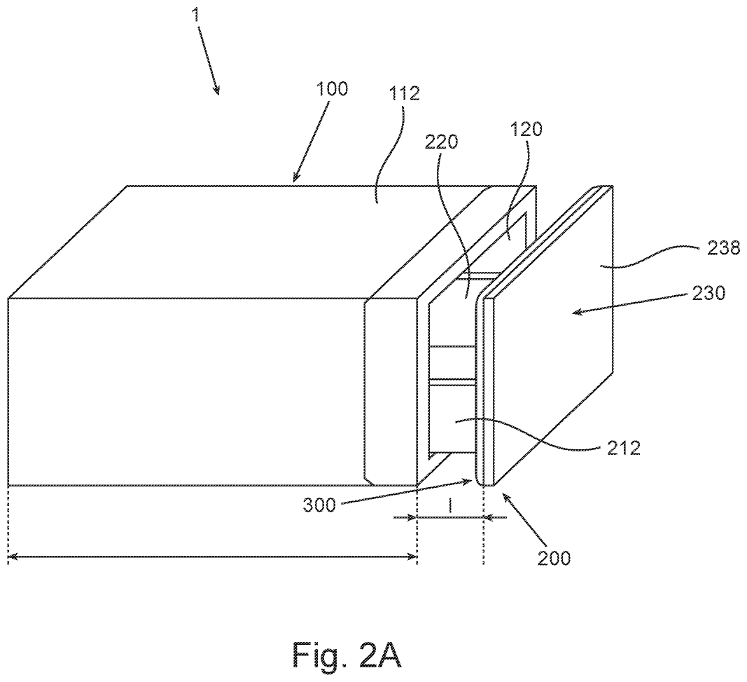

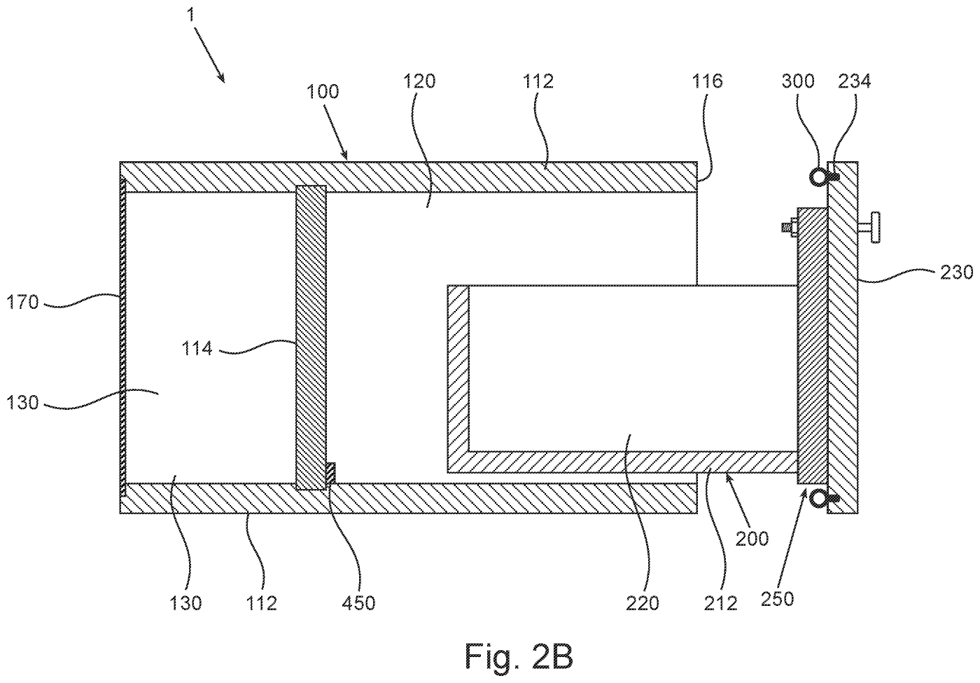

Turning now to FIGS. 2A and 2B, the VCS is shown in an open position, wherein the container 200 is only partially received within the housing 100, and has a portion thereof protruding from the housing 100. The sealing area 236 of the front panel 230 is spaced from the sealing rim 116 of the chamber 110. In this position, no sealing is provided between the housing 100 and the container 200, the container cavity 220 is not pressurized and it is accessible to a user for the purpose of freely placing items therein or removing items therefrom.

It is also noted that the housing comprises an activator 450 in the form of a button located at the rear of the chamber cavity 220, configured for activating the vacuum mechanism 400 upon contact. As shown in the open position, the rear wall of the container 200 is spaced from the activator 450, whereby the vacuum mechanism remains inactive in this open position.

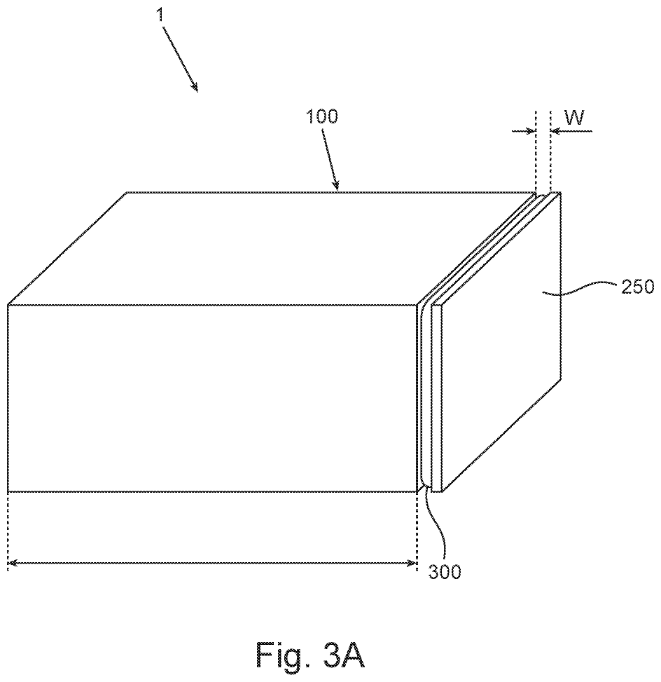

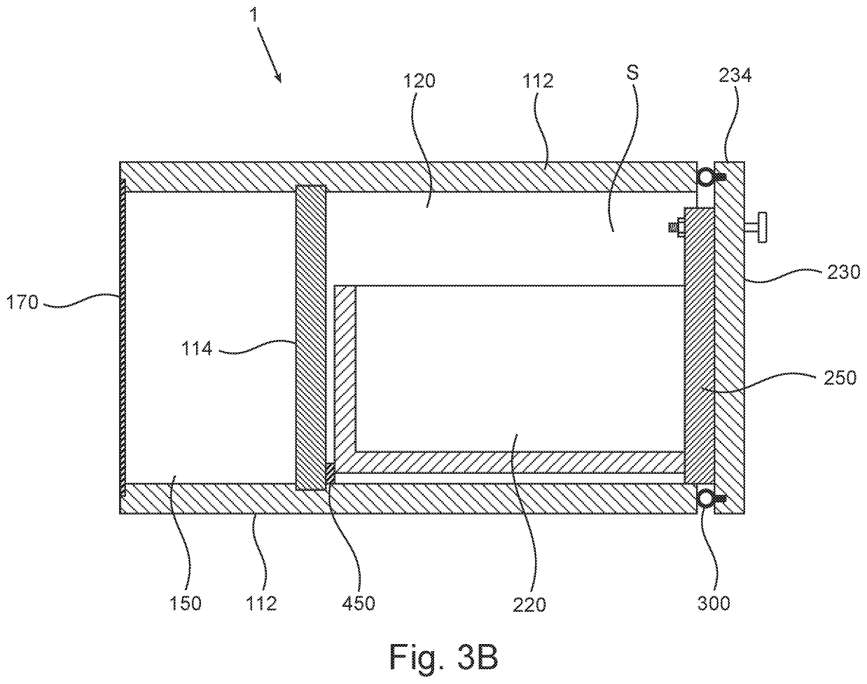

Turning now to FIGS. 3A and 3B, the VCS 1 is shown in a closed position, in which the container 200 has been transposed to become fully received within the chamber cavity 120. In this position, the sealing area 236 of the front panel 230 and the sealing rim 116 of the chamber 110 are juxtaposed with one another, with the sealing member 300 positioned therebetween. In the position shown, the chamber cavity 120 and the container cavity 220 form together a single mutual space S.

It should be noted that in the shown position, while sealing is provided between the container 200 and the chamber 210, the mutual space S is still not pressurized, and thus the position is considered closed, but not yet sealed. It is also noted that in this position, the sealing member 300 is only slightly deformed and comes into contact with both the front panel 230 of the container 200 and the sealing rim 116 of the housing 100. However, in the position shown, the rear portion of the container 200 comes into contact with the activator 450, thereby triggering activation of the vacuum mechanism 400.

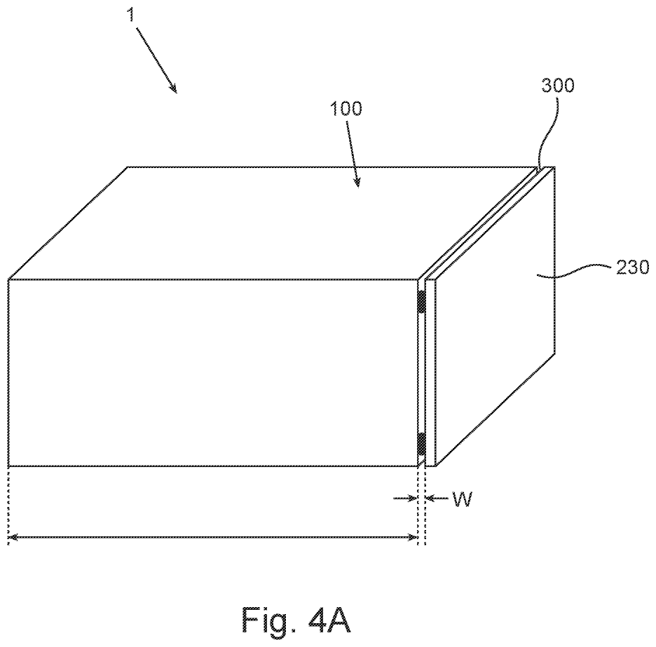

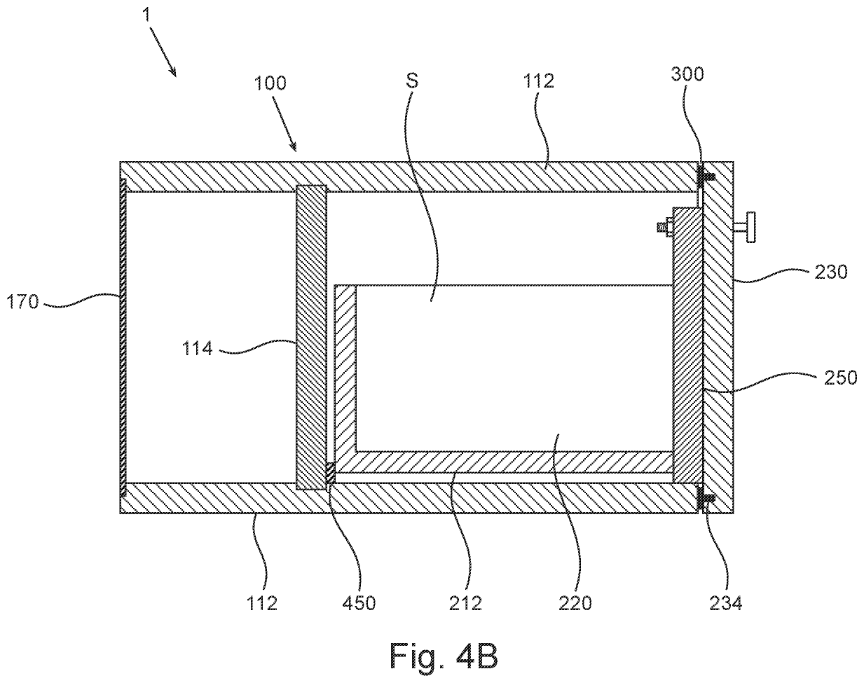

Turning now to FIGS. 4A and 4B, when the pressure mechanism 400 is activated, air is withdrawn from the chamber cavity 120, and, consequently from the mutual space S. Owing to the under pressure, the container 200 is further withdrawn into the chamber cavity 120, and the sealing member 300 becomes deformed. When a sufficient/required amount of air has been withdrawn from the mutual space S, and the under pressure has reached its desired level, the VCS 1 can be considered to be in a sealed position. It should be noted that once the desired under pressure within the mutual space S is reached, the pressure mechanism 400 may be configured for cancelling/decoupling the activator, so as not to trigger the vacuum mechanism 400 any further.

In addition, owing to the under-pressure formed within the chamber cavity 120, the walls 112 of the housing 100 are stressed to buckle into the chamber cavity 120. In order to mitigate this effect, the front panel 230 comprises a support panel 250 configured for being received within the chamber cavity 120 at least in the closed and sealed positions. Thus, in the sealed position, the support panel 250 provides a rigid support for the front portion of the walls 120, preventing them from buckling.

An additional effect of the support panel 250 is that it prevents dislocation between the sealing rim 116 and the sealing area 236 of the front panel 230. Specifically, if the walls 112 could buckle further (even without damaging the structural integrity of the housing 100), the shape/size of the sealing rim 116 might have changed, thereby hindering the sealing.

Furthermore, the construction of the rear panel 114 within the grooves 113 of the walls 112 provides an additional level of structural integrity to the housing 100. Specifically, since the rear panel 114 is received within the grooves 113, it cannot be dislodged or pulled inwards under pressure. One additional advantage of such an arrangement is that the sealing material within the grooves 113 fully encloses the peripheral edges of the rear panel 114, facilitating better sealing.

The support panel 250 and the construction of the rear panel 114 provide the housing 100, individually and/or collaboratively, with sufficient structural integrity to support a fairly large volume of the chamber. In particular, in the present example, the vacuum chamber 100 has dimensions of 400 mm×250 mm×600 mm (width×height×depth respectively), the walls 112 having a thickness of around 17 mm. This provides a cross-sectional diagonal of about 47 cm, yielding a ratio of roughly 27.5 of cross-sectional length to wall thickness. Similarly, this provides a chamber cavity volume of roughly 60,000 cm³ (0.06 m³), while having a volume of about 14,000 cm³, yielding a ratio of about 4.28 of cavity volume to wall volume.

In the sealed position the mutual space S is under vacuum/under-pressure, whereby any items placed therein are in a vacuum/under-pressure environment, experiencing the same effect as if the items were placed in a vacuum sealed bag or container. Furthermore, owing to the under-pressure, it is impossible (or at least increasingly difficult) to simply pull the container out, back to its open position.

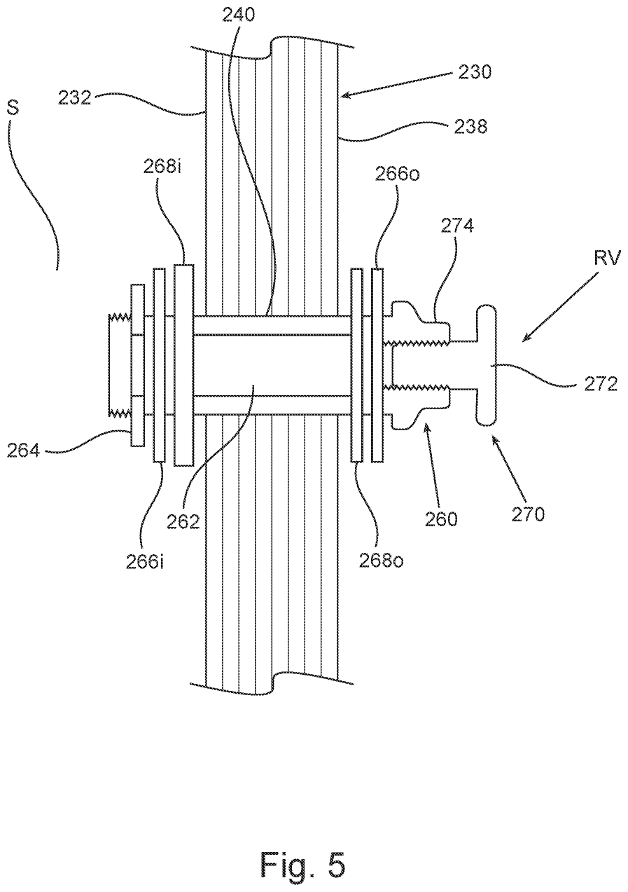

With attention being drawn to FIG. 5, when it is required to transpose the VCS 1 from the sealed position back to the closed/open positions, it is first required to release the under pressure in the mutual space S. Such a release is performed using a release valve RV comprising a valve base 260 extending through a cavity in the panel 230, and a valve head 270 threadingly received within an inner channel 262 of the valve base 260, thereby effectively sealing the channel 262. The valve base 260 has an inner and an outer flange 266ᵢ and 266ₒ respectively, and corresponding inner and outer seal rings 268ᵢ and 268ₒ respectively. In addition, the inner end of the valve base 260 is formed with a thread configured foe receiving thereon a nut 264 for sealingly fixing the valve base 260 to the panel 230.

In the position shown in FIG. 5, the valve head 270 is received within the valve base 260 and prevents ingress of air into the mutual space S. In order to release the vacuum, it is required to balance the pressure between the mutual space and the outside environment by letting air into the mutual space S. Thus, when the valve head 270 is turned and sufficiently pulled from the channel 262, air is allowed to enter the mutual space S and the pressure is balanced out. Once air is introduced into the mutual space S, the container 200 may be pulled out and retracted from the housing 100 into its second, open position.

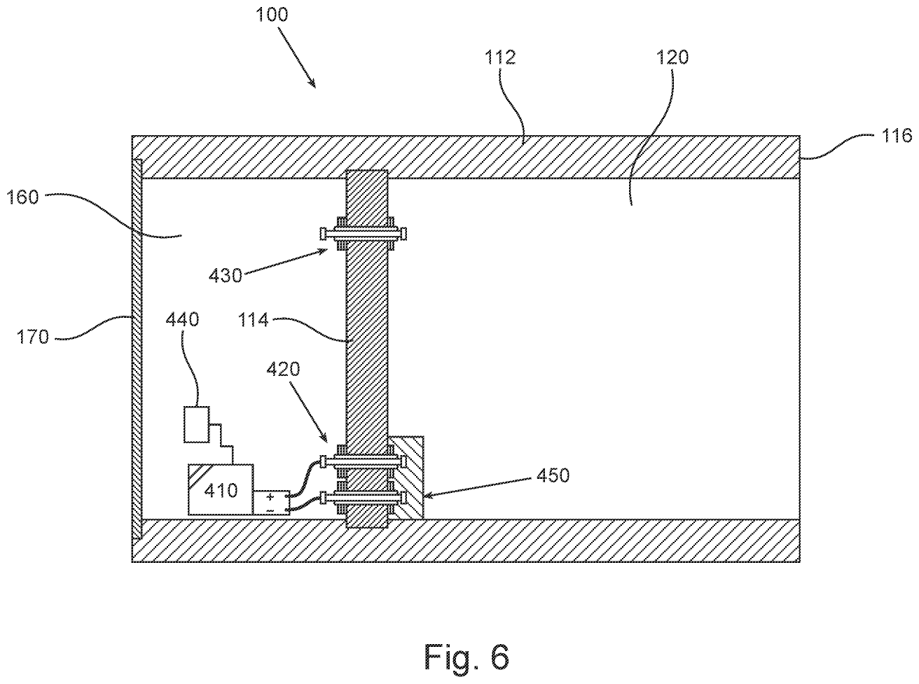

Attention is now drawn to FIG. 6, in which the pressure mechanism 400 is shown positioned in the rear compartment 160 of the housing 100. The pressure mechanism 400 comprises a pump 410, a main valve 420 and a pressure regulating valve 430, both being in fluid communication with the chamber cavity 120, and a control module 440 associated with the pump 410.

In operation, when the activator 450 is activated by the container 200, an electrical signal is sent to the pump 410, which begins to withdraw air from the chamber cavity 120 via the main valve 420. The pressure regulating valve 430 is calibrated according to the structural parameters and constraints of the housing, preventing the under-pressure within the chamber cavity 120 from dropping below a level which may compromise the structural integrity of the housing 100.

It should be noted that all elements extending between the chamber cavity 120 and the rear compartment 160 are sealingly received within the rear panel 114, thereby preventing any leaks from the chamber cavity 120. The rear access panel 170 is provided for convenient maintenance access directly to the vacuum mechanism 400 of the VCS 1.

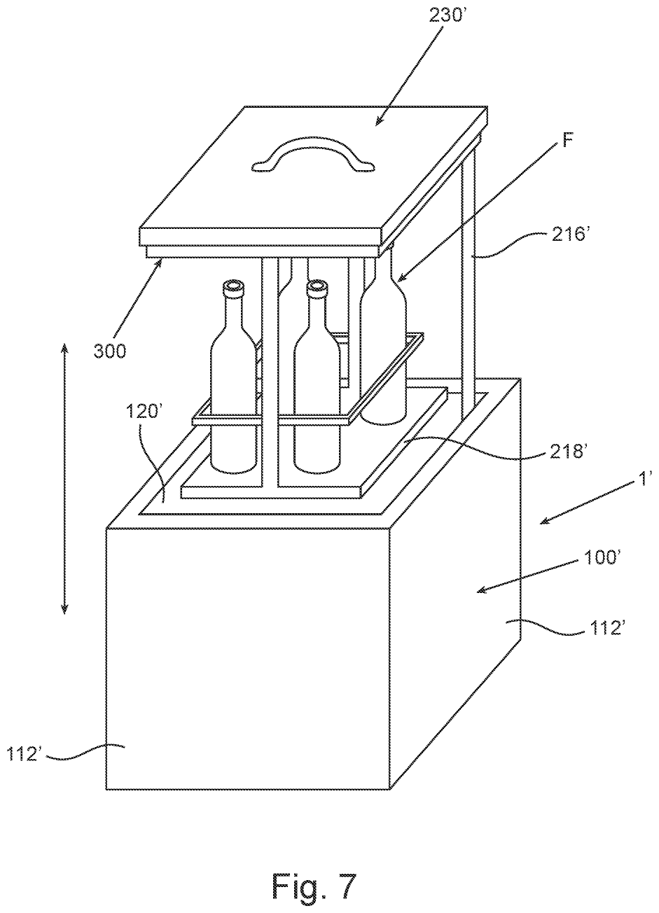

Turning now to FIG. 7, another configuration of a VCS is shown, generally designated 1′, and similarly comprising a housing 100′, a container 200′, a seal 300′ and a vacuum mechanism (not shown). The VCS 1′ operates in an identical manner with the sole difference being in the vertical configuration of the VCS 1′ as opposed to the horizontal configuration of the VCS 1 previously described. Specifically, in the present example, the rear wall 218′ of the container 200′ serves as the bottom of the container 200′. Thus, in the given example, the container may require only a single wall 216′ associating it with the bottom 218′. This configuration may be suitable for holding bottles of open beverage (e.g. wine) and or any item requiring a vertical configuration during storage.

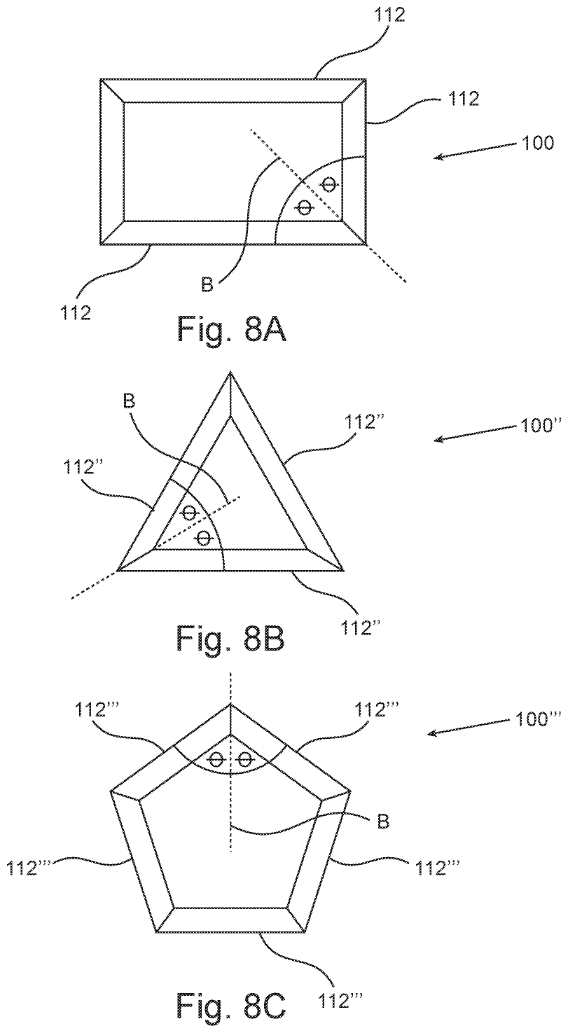

Attention is now drawn to FIGS. 8A to 8C, in which different examples of possible geometries of housings are shown. In the example shown in FIG. 8A, the geometry of the housing 100 is shown having four wall panels 112 forming a rectangular shape. Each wall 112 has a 45° chamfer, forming contact surfaces 118 on each side of the wall panel 112. Thus, when two panel walls 112 are fitted to one another, contact is provided between the chamfer surfaces 118. The arrangement of chamfered surfaces 118 provides an additional degree of structural support for housing, allowing it to withstand the stress applied to it by the under pressure formed within the housing in the sealed position of the VCS 1.

It is noted that the 45° angle θ is chosen owing to the rectangular configuration of the housing, since the 45° is a bisector of the angle between two panel walls 112. Thus the symmetry eliminates any structural bias of the wall panels 112 when stressed by the under pressure.

With particular reference being made to FIG. 8B, in a triangular configuration, and specifically an equilateral triangle, the angle θ is chosen as 60°. Similarly, with reference to FIG. 8C, in a pentagonal configuration, the angle θ is chosen to be 54° and so on.

While it is appreciated that a symmetric polygonal configuration provides a more even distribution of the stress on the wall panels 112, any geometry may be applicable. However, it may be desired to choose the angle between each two wall panels 112 to still be the bisector of the angle between the panels.

The wall panels 112 may be made of plastic, metal, wood etc., or any material configured for withstanding stress and strain under pressure. In the specific case of wood, a resin may be applied to the wall panels 112 in order to increase their structural integrity.

Those skilled in the art to which this invention pertains will readily appreciate that numerous changes, variations, and modifications can be made without departing from the scope of the invention, mutatis mutandis.

1. A vacuum chamber system comprising:
a housing defining therein a chamber cavity, and an opening in said housing leading to said chamber cavity, said housing having a sealing rim extending around the opening;
a container configured for being accommodated within the housing and comprising a panel formed with a sealing area corresponding in size and shape to said sealing rim; said container being configured for transposing at least between a first, closed position in which the container is received within the housing and the sealing area thereof is juxtaposed against the sealing rim, and a second, open position in which the container at least partially protrudes from the housing and said sealing area is spaced from said sealing rim; wherein said container further comprises a support structure configured for being received within the housing in said first, closed position; and
a pressure mechanism configured for withdrawing air from the chamber cavity at least when said container is in its first, closed position, thereby creating an under pressure within the chamber cavity and a sealing between the sealing rim and the sealing area, thereby defining a third, sealed position of the container, wherein said support structure is configured for providing structural support to the housing in said sealed position.

2. A vacuum chamber system according to claim 1, wherein panel also includes a peripheral portion extending beyond the sealing area.

3. A vacuum chamber system according to claim 1, wherein the housing is configured for being properly sealed on all areas of the housing other than the opening, for preventing ingress of air into the chamber cavity at least in the third, sealed position of the chamber.

4. A vacuum chamber system according to claim 1, wherein the container is formed with a container cavity configured for receiving items therein.

5. A vacuum chamber system according to claim 4, wherein, at least in said closed position, the container cavity and the chamber cavity are in fluid communication with one another.

6. A vacuum chamber system according to claim 5, wherein, at least in the first, closed position, the container cavity and chamber cavity form together a mutual space, wherein, upon generating under pressure within the chamber cavity, the container cavity is similarly under pressured.

7. A vacuum chamber system according to claim 5, wherein the container comprises an opening allowing the user access to the container cavity, at least in the second, open position.

8. (canceled)

9. A vacuum chamber system according to claim 1, wherein the container is transposable continuously between the first, closed position and the second, open position to assume a plurality of intermediate positions therebetween.

10. A vacuum chamber system according claim 1, wherein, when the chamber is under pressured, and sealing is provided between the sealing rim and the sealing area, the container is considered to be in a third, sealed position.

11. A vacuum chamber system according to claim 1, wherein the container is transposable between the first, closed position and the second, open position by linear displacement.

12. A vacuum chamber system according to claim 1, wherein the container is transposable between the first, closed position and the second, open position by a revolving motion.

13. A vacuum chamber system according to claim 1, wherein the panel of the container is oriented along a plane generally transverse to the direction of movement of the container in its transition between the first, closed position and the second, open position.

14. A vacuum chamber system according to claim 1, wherein the container further comprises a bottom configured for supporting any items placed in the container.

15. A vacuum chamber system according to claim 14, wherein, when the container is configured for transposing between the positions in a generally horizontal manner, the bottom is oriented along a plane transverse to the panel.

16. A vacuum chamber system according to claim 14, wherein, when the container is configured for transposing between the positions in a generally vertical manner, the bottom is oriented along a plane generally parallel to that of the panel.

17. A vacuum chamber system according to claim 1, wherein the vacuum chamber system comprises a sealing member interposed between the sealing rim and the sealing area, configured for providing the required sealing of the opening to ensure the vacuum is maintained.

18. A vacuum chamber system according to claim 17, wherein the sealing member is either one of the following:
a) integrally formed with the opening;
b) integrally formed with the panel; and
c) a stand alone member configured for being fitted to either of the opening or the panel for providing the required sealing.

19.-35. (canceled)

36. A vacuum chamber system according to claim 1, wherein the support structure is configured for at least partially abutting an inner portion of the housing walls proximal to the opening, thereby providing the required structural support.

37.-43. (canceled)

44. A vacuum chamber system comprising:
a housing comprising one or more housing walls defining therein a chamber cavity, and an opening in said housing leading to said chamber cavity, said housing having a sealing rim extending around the opening, and a rear panel remote from the opening, said rear panel being received within grooves formed in said housing walls;
a container configured for being accommodated within the housing and comprising a panel formed with a sealing area corresponding in size and shape to said sealing rim; said container being configured for transposing at least between a first, closed position in which the container is received within the housing and the sealing area thereof is juxtaposed against the sealing rim, and a second, open position in which the container at least partially protrudes from the housing and said sealing area is spaced from said sealing rim; and
a pressure mechanism configured for withdrawing air from the chamber cavity at least when said container is in its first, closed position, thereby creating an under pressure within the chamber cavity and a sealing between the sealing rim and the sealing area, thereby defining a third, sealed position of the container.

45. A vacuum chamber system comprising:
a housing having one or more housing walls defining therein a chamber cavity, and an opening in said housing leading to said chamber cavity, said housing having a sealing rim extending around the opening, wherein said one or more housing walls have a nominal thickness t and said chamber cavity having a maximal cross-section L such that the ratio of L/t is greater than 15;
a container configured for being accommodated within the housing and comprising a panel formed with a sealing area corresponding in size and shape to said sealing rim; said container being configured for transposing at least between a first, closed position in which the container is received within the housing and the sealing area thereof is juxtaposed against the sealing rim, and a second, open position in which the container at least partially protrudes from the housing and said sealing area is spaced from said sealing rim; and
a pressure mechanism configured for withdrawing air from the chamber cavity at least when said container is in its first, closed position, thereby creating an under pressure within the chamber cavity and a sealing between the sealing rim and the sealing area, thereby defining a third, sealed position of the container.
